(19) United States
(12) Patent Application Publication
(10) Pub. No.: US 2010/0198881 A1
(43) Pub. Date: Aug. 5, 2010

(54) METHOD OF DATA STORAGE AND MANAGEMENT

(75) Inventors: Kim Seng Kee, Kuala Lumpur (MY); Chee How Stephen Peh, Petaling Jaya (MY); Khairul Nizam Abdul Halim, Petaling Jaya (MY); Wing Seong Wong, Kuala Lumpur (MY); Chee Yong Choo, Petaling Jaya (MY); Soo Hoe Nah, Kuala Lumpur (MY); Yuan Kai Chow, Kuala Lumpur (MY); Ket Yong Yee, Kota Damansara (MY); Tuck Pool Yap, Kuala Lumpur (MY)

Correspondence Address: DORITY & MANNING, P.A., POST OFFICE BOX 1449, GREENVILLE, SC, 29602-1449, US

(73) Assignee: E-MANUAL SYSTEM SDN. BHD., Kuala Lumpur (MY)

(21) Appl. No.: 12/529,456

(22) PCT Filed: Mar. 3, 2008
(86) PCT No.: PCT/MY2008/000017

§ 371 Date: Apr. 22, 2010

(30) Foreign Application Priority Data
Mar. 2, 2007 (MY) PI 20070321

(51) Int. Cl. G06F 17/30

(52) U.S. Cl. 707/803; 707/E17.005; 707/802

(57) ABSTRACT

The present invention relates to a method of electronic data storage, integration, management, retrieval and organization that mimics the physical filing system through the use of account-centric non-table driven methodologies. The method of the present invention stores data related to the same account in an account-centric ledger file, where such ledger is a virtual folder that is being implemented using DBMS as the filing apparatus. The data as stored in the ledger can be retrieved as a whole when requested. Another embodiment of the present invention relates to a computer program having a module where execution of said module generates the method for storing, integrating, managing, retrieving and organizing data in accordance with the present invention.

### FIELD OF INVENTION

The present invention relates to a method of electronic data storage and management.

### BACKGROUND OF THE INVENTION

Many businesses, organizations, and the like, have a need to store large amounts of data or documents in an organized manner such that the data or documents can be readily found when necessary.

In the conventional paper-based filing system, information related to customers, products, transactions and other business related information are recorded in documents and are generally grouped in ledger files (folders). The major advantages of a paper-based filing system are its flexibility towards change and its way of organizing the data by grouping the relevant documents into one location. While such systems are common and presently working, managing large amounts of such documents may be rather tedious and bulky to deal with. For instance, it would be necessary to physically read through the bulky documents one page at a time in order to locate information needed. Such reading of these documents is usually completely impractical as it is extremely time consuming and much of the information needed could be easily overlooked.

The advance in computers and software technology has resulted in the creation of many databases and the databases are used in a variety of different computer systems to store and manage large amounts of data and documents. However, as technology advances, the systems become more and more complex. The initial database technology developed was limited by the prevailing software and hardware limitation. The eventual introduction of Relational Database Management System (RDBMS) technology in the 1970s by IBM begins to resolve most of the fundamental issues in database design.

RDBMS is a database management system (DBMS) which uses relational techniques for storing and retrieving data. RDBMS organizes and stores data in tables which consist of rows and columns. RDBMS will typically consist of many tables and each table will typically have multiple rows and multiple columns. In RDBMS, information is linked by relational principal, and organized by grouping related data together in a table. For example, a contact information table stores customer addresses and telephone information, a complaint table stores all complaints from customers, and the like.

RDBMS often does not allow users to effectively retrieve all relevant files easily, especially when a complex system is involved. In addition, the existing data management systems also fail to allow users to retrieve effectively and easily the entire history of an account of a particular account, product or project. This is disadvantageous as the history of the account may be needed from time to time to understand customer queries or complaints.

RDBMS requires one important activity, namely data normalization. Data normalization is a process whereby the business data is structured to eliminate redundancy and maintain data integrity, the data is organized into tables, and this may reduces the potential for anomalies during data operations. Normalizing the data is a process of breaking down a single relation into a set of smaller relations which satisfy the constraints of the original relation. Business data is spread across multiple tables and represents purely partial data or information. Some technique of data mining will have to be programmed to obtain information from the database.

In RDBMS implementation however, as data is normalized and stored to different tables, to assemble a similar record for a customer will require substantial coding to retrieve respective data from several tables. The situation becomes worse when a more complex application is involved, with several different systems holding data in different ways are involved, especially since table design can be different for each system although they might all be using RDBMS). This demonstrates one of the biggest problems in RDBMS design, that even with the same set of requirements you can have different table designs arising due to having different people designing the system or even the same person who designing the system at different times.

Some of the products in the market aim towards trying to solve the problem of the data normalization in RDBMS. For instance, Intersystems Corporation's CACHE program tries to solve the problem by representing the document in an object oriented method through the use of “Class Object”s. A “Class Object” is an individual unit of run-time data storage that is used as the basic building block of programs. The CACHE program stores data in multidimensional arrays. This method allows data to be accessed as both objects and tables. It allows for an object stored under the CACHE program to be visualized as a document.

Storing of Extensible Markup Language (XML) documents is another challenge in RDBMS. XML at its base level manifests all information as text, interspersed with markups or tags that indicate the said information's separation into a hierarchy of character data, container-like elements, and attributes of those elements. An XML structure can be used to represent a document and be stored in an XML database. XML provides a text-based means to describe and apply a tree-based structure to information which can be used to represent a business document.

Both the above examples however do not lend themselves for business users to view the represented documents as business documents. They are merely a representation of objects for the programmer to utilize in achieving the programming aspect of the business, rather than as a business object. It becomes even more difficult when documents of old and revised versions need to be stored and managed together.

A further problem of the current methodologies is that the applications can take many man hours to build and program, so much so that business requirements may have changed before the system is completed, often resulting in wasted expenses and unusable systems.

Presently, changes in business requirements involve either having to amend and re-program present applications often resulting in a much less efficient system or require starting over and designing a whole new set of tables.

Hence, there is a need to provide a method for storing and managing electronic information on computers in an easy and efficient manner where the information is easily retrievable and be readily found when needed.

### SUMMARY OF THE INVENTION

It is an object of the present invention to address and overcome the above-described limitations and shortcomings by providing a method of electronic data storage and management that simulates the storage and management system of physical documents.

Another object of the present invention is to solve the complexity of business data storage using RDBMS which involves data normalization that breaks the business data into groups of fields and therefore loses the cohesive grouping of business data or information.

One aspect of the present invention allows users to store, retrieve and routing electronic data in a way that mimics a physical filing system.

Another aspect of the present invention is to provide an electronic data storage and management method that simulates the physical filing system which uses the ledger-file (folders), documents and paper. A method of the present invention simulates the physical filing system where information is recorded in the format of documents and is stored in a virtual ledger file and the posting is affected by posting documents to the ledger files.

Another aspect of the present invention provides an account- or customer-centric filing system where the information of the same customer is stored in the same location instead of being spread across multiple tables.

A further aspect of the present invention provides a storage means having a virtual ledger folder comprising a section to store the particulars of an account, an area to store at least an activities summary of the account and at least an electronic page to store information related to the account.

Another aspect of the present invention provides a method of electronic data storage and management system where the data obtained from paper documents is converted into a pre-determined structure which is computer readable.

A further aspect of the present invention provides a method of electronic data storage and management where data converted into the pre-determined structure is appended onto an electronic page in chronological order to form a fully traceable sequence-of-events of the account.

Another aspect of the present invention allows retrieval of data and generation of an activities summary about the account.

A further aspect of the present invention provides an electronic data storage and management method which simplifies the backend design of a system as compared to a conventional RDBMS table driven approach. Another aspect of the present invention provides the capability to have a full audit trail of the documents stored in the ledger-filing system.

Yet another aspect of the present invention provides a computer usable medium tangibly embodying a program of instructions executable by the computer to perform the afore-mentioned method.

The electronic ledger-filing system of the present invention is intended to simulate the ledger-filing system that stores data or information as documents. This ledger-filing system is still one of the best and proven approach in handling information and data in the business world. The document-based ledger-filing system of the present invention not only provides a better way of data storage and retrieval, it also produces an audit trail to the users for every action taken to a posting or updating of data. Clearly, a technology that allows users work in the way that similar to how human handle data is a huge advantage. One embodiment of the present invention relates to a method of electronic data storage, integration, management, retrieval and organization comprising the steps of: (a). obtaining data; (b). converting said obtained data into an electronic document having a pre-determined structure which is computer-readable; (c). storing said electronic document in a temporary storage means where all the converted data are stored; (d). identifying destination file to store said electronic document; (e). retrieving a pre-determined electronic page of said destination file where the most recent electronic document is recorded; (f). appending said electronic document onto said retrieved page in chronological order; (g). updating said destination file according to the data of said electronic document as appended; (h). storing said destination file in a specific storage means. The above-mentioned method is an account-centric non-table driven method where electronic documents of the same account are grouped and stored in the same location.

Another embodiment of the present invention provides a computer-based filing system for use in a relational database which utilizes a non-table driven approach having at least a storage means with at least a virtual folder which comprises:

i). a section to store particulars of an account;
ii). at least an electronic page to store an activities summary of the account;
iii). at least an electronic page to store at least an electronic document with a plurality of data arranged in a pre-determined structure.

The method or system of the present invention is an account-centric non-table driven method where electronic documents of the same account are grouped and stored in the same location.

A further embodiment of the present invention provides a computer program having a module for storing, integrating, managing, retrieving and organizing data obtained from a paper resource where execution of said module generates the afore-described method for storing and managing data.

A further embodiment of the present invention relates to a computer system comprising at least:

i). a processor
ii). a memory device operatively coupled to said processor;
iii). a storage medium operatively coupled to said processor; the memory device is stored with a module where execution of the module by the processor generates the afore-described method for storing and managing data.

### BRIEF DESCRIPTION OF THE DRAWINGS

FIG. 1 is a process flow diagram of the method according to one embodiment of the present invention for storing and managing electronic data.

FIG. 2 illustrates the concept of the e-Ledger which comprises Line-0, Document-0 and ePages as defined in the Detailed Description of the Invention according to one embodiment of the present invention.

FIG. 3 illustrates the ledger-filing system of the present invention and how the Line Zero, Document Zero and Document X as defined in the Detailed Description of the Invention relates to the physical filing system.

FIG. 4 illustrate an example of a multi-value hierarchical structure data format according to the present invention.

FIG. 5 illustrates an example on how a conventional invoice is structured into the format of D-S-R-C as defined in the Detailed Description of the Invention.

FIG. 6 illustrates an example of an ePage as defined in the Detailed Description of the Invention comprises ten columns with each of the columns having a size of 128 bytes forming a 1,280 bytes ePage (10×128).

FIG. 7 illustrates an example of an ePage implementation using a conventional table-based DBMS.

FIG. 8 is a diagram on how the transaction eLedger and document processor (eDP) as defined in the Detailed Description of the Invention interacts with each other to perform the posting and updating processes.

FIG. 9 illustrates an example of Library eLedger as defined in the Detailed Description of the Invention which is implemented using normal DBMS tables.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments.

The present invention relates to a system and a method for storing and managing information as documents. It should be noted that the present invention discloses an electronic ledger-filing system, which may file any relevant data to an appropriate account-centric ledger, where such ledger is a virtual folder that is being implemented using DBMS as the filing apparatus.

A method according to the present invention relates to a method of electronic data storage, integration, management, retrieval and organization that mimics the physical storage, integration, management, retrieval and organization of documents through the use of account-centric non-table driven methodologies.

The electronic ledger-filing system of the present invention comprises one or more DBMS databases, each database representing a system or application, such as the Customer Information Management System, Human Resource Management System, and On-line Job Posting and Management System. The electronic ledger-filing system of the present invention also includes software to manage the creation, modification and maintenance of such systems. As illustrated in the following discussion, the present system allows a user to generate and to customize each of the systems. It is important to point out that each of the generated systems has substantially the same set of table designs, but with different business rules and flows.

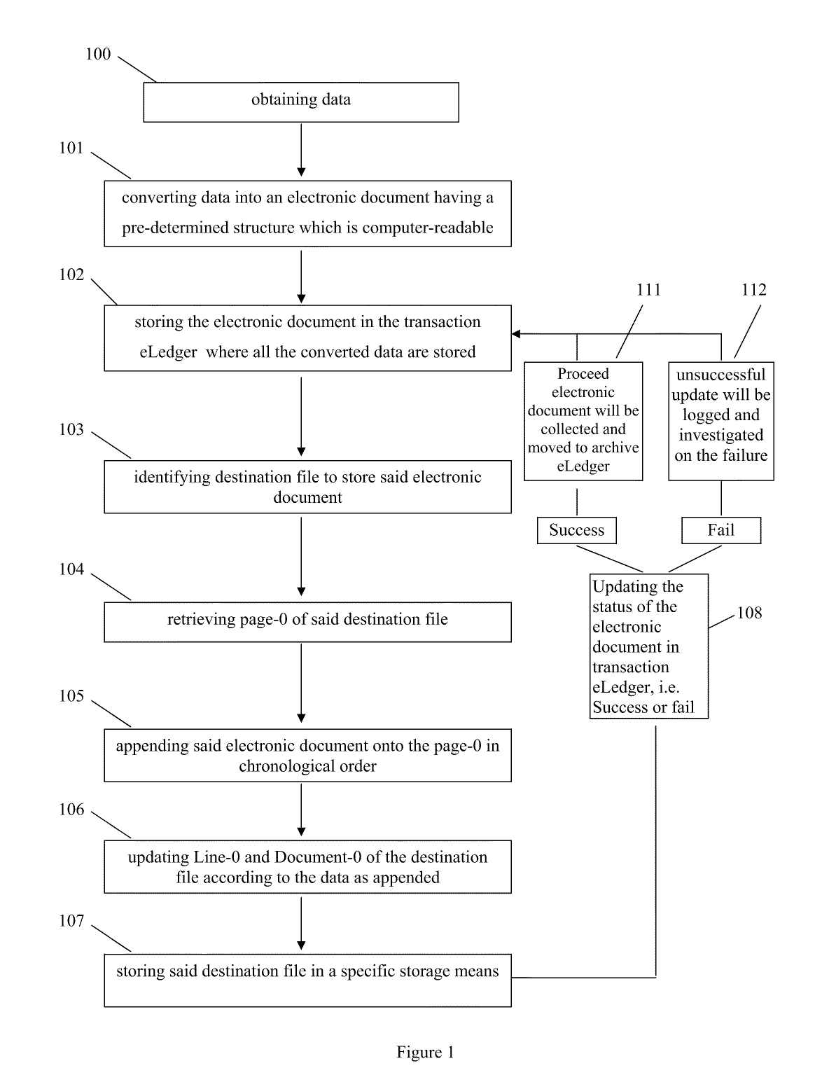

FIG. 1 illustrates the process flow of the preferred embodiment according to the method of the present invention. In one embodiment of the present invention, a method of electronic data storage, integration, management, retrieval and organization comprising the steps of:

a). obtaining data from a paper document (100);
b). converting said obtained data into an electronic document having a pre-determined structure as defined in the following description (101);
c). storing said electronic document in a temporary storage means where all the converted data are stored (102);
d). identifying destination file to store said electronic document (103);
e). retrieving a pre-determined electronic page of said destination file where the most recent electronic document is recorded (104);
f). appending said electronic document onto said retrieved page in chronological order (105);
g). updating said destination file according to the data of said electronic document as appended (106); and
h). storing said destination file in a specific storage means (107)

The filing system of the present invention which is implemented using a conventional RDBMS complements the strength of an RDBMS and SQL query language by effectively extending the usage of the RDBMS to store and retrieve complex data objects as a document. The ledger filing system of the present invention is implemented in such a way that the ease and speed of SQL query is maintained, while the fixed length columns of RDBMS are extended to allow the storage of variable length data and hence document object. In short, the present invention eliminates much of the cumbersome join syntaxes when retrieving data of an account, document or object, whilst maintaining the powerful nature of SQL language for searching and reporting.

In the computer environment, data from a document will be broken down and stored in several tables according to the criteria of data. For example, an invoice document might contain company details, total amount, account reference, and the like, and it may also contain attachments or references to other documents, a conventional RDBMS system breaks down such data and stores such data into several tables and causes a lot of complexity when this document is to be retrieved or reconstructed for reviewing. However, in the physical filing system, a document is treated as an object, therefore the data in a document will not be broken down to several storages but will be stored as a whole document. The ledger-filing system of the present invention therefore attempts to mirror how data and information is stored and filed in physical folders and is retrieved as a document when the data is needed.

Another embodiment of the present invention provides a computer-based filing system for use in a relational database which utilizes a non-table driven approach having at least a storage means with at least a virtual folder which comprises:

i). a section to store particulars of an account (18);
ii). at least an electronic page to store an activities summary of the account (16);
iii). at least an electronic page (12) to store at least an electronic document (14) with a plurality of data arranged in a pre-determined structure.

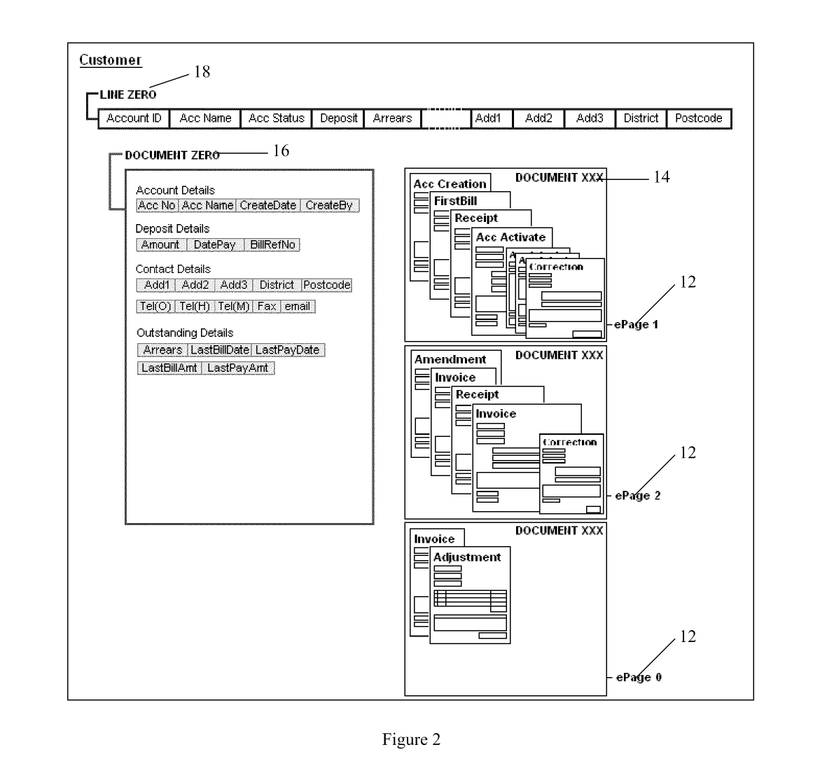

FIG. 2 is an overview diagram of the filing system in accordance with the present invention. As illustrated in FIG. 2, the section to store particulars of an account is represented by Line Zero (18); the electronic page to store an activities summary of the account is represented by Document Zero (16); the electronic page to store at least one electronic document is represented by ePage (12) and the electronic document is represented by Document X (14). The terms Line Zero (18), Document Zero (16), ePage (12), and Document X (14) as shown in FIG. 2 will be defined in the following description.

The terms used in the present invention will now be explained in more detail as follows:

eLedger

The term eLedger as used herein is a storage means representing a virtual cabinet of the filing system according to the present invention. Each eLedger (10) comprises at least a virtual folder having a collection of Line Zero (18), Document Zero (16) and Electronic Page (12) comprising Document Xs (14). The collection of Line Zero (18), Document Zero (16) and Electronic Page (12) comprising Document Xs (14) are organized in an account centric manner as illustrated in FIG. 2.

Each virtual folder will have at least one Line Zero (16), one Document Zero (18) and one Electronic Page (12) that holds multiple electronic documents (14). The eLedger (10) of the present invention can be implemented using a normal DBMS as a table.

Electronic Document (eDocument)

The term electronic document is used herein as a term to define the data obtained from a paper document, and that has been converted into a pre-determined structure according to the present invention.

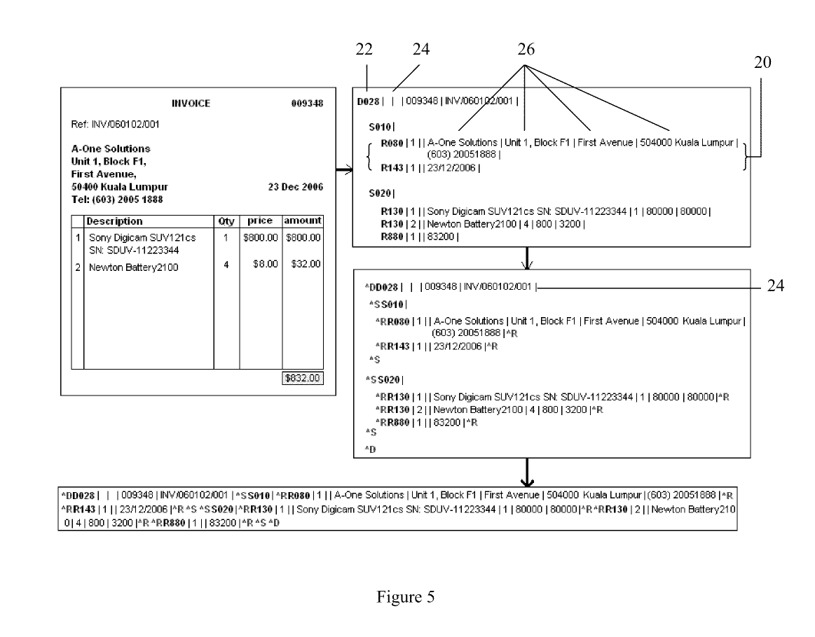

The pre-determined structure is a hierarchical document structure comprising a coding system. The hierarchical document structure in accordance with the present invention is formed by a plurality of elements which are arranged in rows forming a string of characters (20) as illustrated in FIG. 5. The plurality of elements comprises at least a unique element code (22) and at least an element data set (26). The plurality of elements is denoted by at least a marker (24).

FIG. 4 shows an example of a multi-value hierarchical structure data format. The example illustrates how data can be organized according to the structure of the present invention, i.e. in D-S-R-C format, where D represents the document code, S represents the section code, R represents the row code and C represents the field position. An example on how the data from a conventional invoice can be structured into the format of D-S-R-C of the present invention is illustrated in FIG. 5. It should be noted that eDocument actually is a string of characters (20) with certain markers (24) to denote the sections of D-S-R-C. The format is similar to the XML format, but the present invention uses markers and codes to denote the elements instead of tags. This optimizes the storage requirements of a document whilst maintaining the XML flexibility and structure.

Electronic Page (ePage)

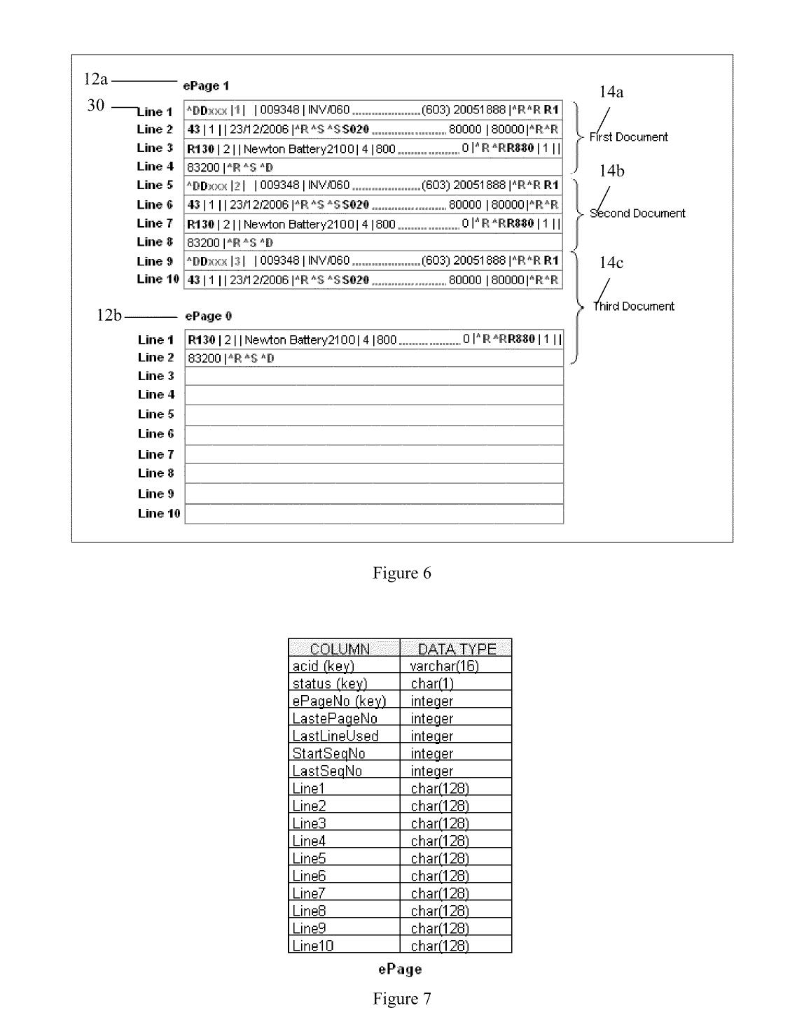

The electronic page as used herein refers to a virtual page that stores at least an electronic document. The electronic page of the present invention comprises at least a fixed length column for the storage of variable length data. The electronic page comprises multiple blocks of columns with each column having a substantially equal length. The columns of the ePage are shown as Lines 1-10 in FIG. 6 as an example. In the preferred embodiment of the present invention, each of the columns is preferably 128 bytes in size.

Depending on the needs, the size of the ePage can be customized to achieve optimum performance. FIG. 6 shows examples of ePages having 10 blocks of columns with each of the columns having 128 bytes forming a 1,280 bytes ePage (10×128).

Each of the electronic documents (14) appended onto said electronic page (12) starts at a new block of column and may continue to the next new block of column whenever the current column is full and the electronic page may continue to the next electronic page if the current electronic page is full. This feature enables better storage performance and improves subsequent retrieval speed. As shown as an example in FIG. 6, the first electronic document (14a) is appended onto the first column, i.e. Line 1, of the electronic page (12a) until the first column is full. The remaining part of the electronic document (14a) is then appended onto the second column, i.e. Line 2. This process continues until the entire electronic document is completely appended onto the electronic page (12a). When a second electronic document (14b) is to be appended onto the same electronic page (12a), the second electronic document (14b) is started a new column, i.e. Line 5, as shown in FIG. 6. Similarly, the second electronic document (14b) continues to the next new column until the whole string of characters is completely appended onto the electronic page (12a). In FIG. 6, the electronic page (12a) is full when part of a third electronic document (14c) is appended onto the electronic page (12a), i.e. Line 9 and Line 10. A new electronic page (12b) is then generated for the remaining part of the third electronic page (14c) to be appended onto the new column of the new electronic page (12b).

Whenever an electronic document is to be posted into the account, a pre-determined electronic page will be retrieved and the electronic document will be appended onto the pre-determined electronic page. The pre-determined electronic page is the page where the most recent electronic document is recorded. The page is given a specific identification so that it is always recognized as the most recent page and will be retrieved whenever a relevant electronic document is to be posted into the account. Preferably, the identification of the pre-determined electronic page is in the form of page-N₀, where N₀ is the first member in a set of symbols with a fixed order. Whenever said pre-determined electronic page is fully appended with electronic documents, the identification of the page will be changed to page-N, where N is the members of said set of symbols and a new page will be generated and given the identification of page-N₀. In the preferred embodiment of the present invention, the page-N₀ is preferably page-0 and N is preferably a positive integer.

For instance, whenever one or more electronic documents (Document Xs) are posted and filed to an account, it will be appended to electronic page-0 (ePage 0), and whenever the ePage 0 is fully appended with electronic documents, it will be renamed to electronic page-1. As illustrated in FIG. 6, when a new electronic document is posted to this account, it will be appended to the ePage 0 (12b). When ePage 0 (12b) is full, it will be renamed to ePage N (1 in this case) (12a) and subsequent electronic documents will be appended to the new ePage 0.

The ePage of the present invention is implemented using a normal DBMS, where each ePage is actually a row of data in a table. A column (character data type with 128 bytes length) represents a line of an ePage. Hence, an ePage of 10 lines when implemented in DBMS is a table with 10 columns, each with character data type of length 128 bytes. A few columns are added to each ePage to form the keys, and several more columns are added to form the index and summary information of an ePage. FIG. 7 illustrates an example of an ePage implementation using a conventional table-based DBMS.

### Document Zero (Document-0)

The term Document Zero as used herein refers to an area that stores an activities summary of the account. It is equivalent to the index page of a physical folder. The Document Zero of the present invention stores variable length data. The Document Zero will be updated accordingly whenever an electronic document is appended onto the system.

Document Zero is stored in the same manner as Document X, except for the ePage number which will start from negative-one (−1), and the last page is numbered as page negative-n (−n). There is no limit to how many units of Document Zero can be stored for an account, as long as each Document Zero contains a unique identification so as the relevant Document Zero is retrieved whenever the activities summary of the account is requested.

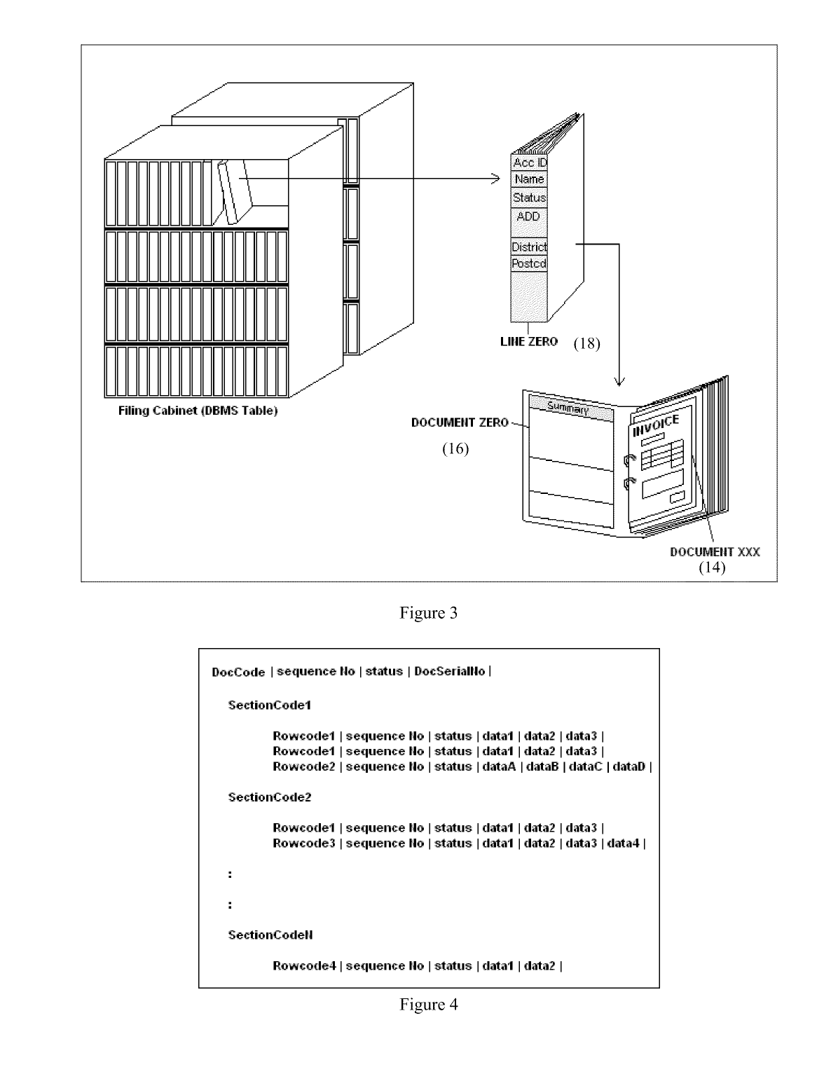

Document Zero (16) is actually mimicking a physical filing folder where one can have more than a page of summary clipped at the side of the front page as illustrated in FIG. 3 and it is a derived document from Document Xs. Each Document X posted and appended to an account may update certain information to the Document Zero and Line 0, and will act as the supporting document to the information change at Document Zero. Document Zero always holds the latest and current information of an account.

### Line Zero (Line-0)

The term Line Zero as used in this specification refers to a section that stores particulars of the related account. It is equivalent to a summary note of a physical folder. This section comprises a fixed length area with a plurality of columns for data storage, the columns containing retrieval keywords.

Most of the data reporting, searching and sorting can be achieved by using SQL language directly on this Line Zero (18). Whenever a query keyword is entered into the system, the keyword will be cross-matched with the retrieval keywords of said section for data retrieval purposes. The query keyword according to the present invention is database query language preferably Structured Query Language (SQL).

Document Processor (eDP)

One of the unique features of the present invention is its update program. The data posted to the system are document based and every eLedger will require the same update process, i.e. appending the eDocument (14) to the ePage (12), and updating the data to Document Zero (16) and Line Zero (18). It is therefore possible to employ a standard document processor to process every document even though they are different in length. This is achieved by including a set of update rules to each Ledger-code-Document X pair and adding in a standard instruction row (R000) to every eDocument (14), where R000 may consist of the following fields: ledger, lgcode, accid. By referring to the R000 fields, the Document Processor will cross reference the update rules in the dictionary (Lxxx-Dxxx) and update the Document Zero (16) and Line Zero (18) accordingly.

The present invention preserves the document structure and stores the data to their respective account (e.g. Account Receivable) as a whole, making subsequent retrieval much more elegant and easier. To facilitate SQL query, certain data selected through user interface will be populated or updated to the Line Zero (16) whenever a document is appended to an account. To improve the retrieval further, certain data selected through user interface is updated to the Document Zero (16), to form a summary document of an account. All the electronic documents (Document Xs) (14) are appended in chronically order from the earliest to the latest to produce a fully traceable sequence-of-events of an account.

To achieve a better storage performance, Document X (14) is appended and stored in one or more segment(s) called electronic page (ePage). The amount of Document X (14) that can be stored in an ePage (12) depends on the size of the ePage (12) and depends on the size of the Document X (14). The ePage (12) is fully customizable preferably in multiples of 128 bytes as described earlier to ensure a better subsequent retrieval performance as data with 128 bytes length will be stored in sequence in hard disk in a normal DBMS implementation.

In another embodiment of the present invention, the method of electronic data storage, integration, management, retrieval and organization further comprises assigning each document a priority level and processing each document according to the priority level as assigned. If more than one electronic document (14) is assigned with the same priority level, the electronic documents (14) will be processed in sequence according to the date and time as submitted into the system. Every electronic document (14) as submitted to the system will be first stored in a temporary storage means before it can be processed and posted to their respective destination. In this temporary storage means, the electronic documents (14) are categorized as (i) Urgent, where immediate filing required; (ii) Normal, where the documents will be processed in sequence or (iii) Non-urgent, where documents are processed in batches during off-peak period or when CPU utilization is low.

The processing status of the electronic documents as stored in the temporary storage means will be updated upon appending and updating the relevant electronic document into said destination file. The processing status is an indication showing successful or failure of the appending and updating processes.

By simplifying and unifying all updating processes to one program, the method of the present invention not only reduces the manual work needed to code an update program for each data update, but also reduces the maintenance work needed and eliminating human errors.

Another embodiment of the present invention discloses a computer program having a module for storing, integrating, managing, retrieving and organizing data obtained from a resource where execution of said module generates the afore-described method of data storage and management.

In physical filing system, different cabinets are used to store different folders. Each of these cabinets is vary in size to hold different types of folders. These cabinets are equivalent to the eLedger of the present invention. We observed that most of the present IT systems can be realized by utilizing approximately 10 different types of eLedger, they are:
1. Transaction eLedger
2. Library eLedger
3. Dictionary eLedger
4. Group eLedger
5. Master eLedger
6. Operation eLedger
7. Index eLedger
8. Summary eLedger
9. Audit eLedger
10. Bulk storage eLedger

In physical filing system, a user might uses more than one cabinet to store similar information, albeit they are same type of cabinets. Like wise, eLedger of the present invention can be implemented in a distributed environment where similar data can be stored in more than one table (eLedger), but segregated by accounts characteristics such as region, postcode, etc.

The major difference of the present invention as compared to a conventional RDBMS segmentation is that data is segmented according to accounts instead of columns, i.e. table is split horizontally instead of vertically as in normal RDBMS. This is important to the performance of data retrieval and database maintenance as data that is split vertically requires a much more complex “join” SQL statement.

In the physical filing system, one can further categorize the folders in a cabinet using a divider and labels. This can be easily achieved in the present implementation where one can add a Ledger-code column as a key to an eLedger (table). All folders that belong to the same category will have the same ledger-code and hence provides a virtual divider to the folders. The following examples illustrate more on how this concept be implemented using a normal DBMS.

Transaction eLedger

Transaction eLedger is equivalent to an inbox tray. Every submission of the eDocument will goes through this eLedger before it can be processed and posted to their respective destination. To optimize the performance of the system, the eDocument that is submitted to the transaction eLedger is categorized as Urgent (immediate filing is required), Normal (document will be processed in sequence according to the date and time as submitted to the system), or Non-urgent (documents will be processed in batches during off-peak periods or when the CPU utilization is low).

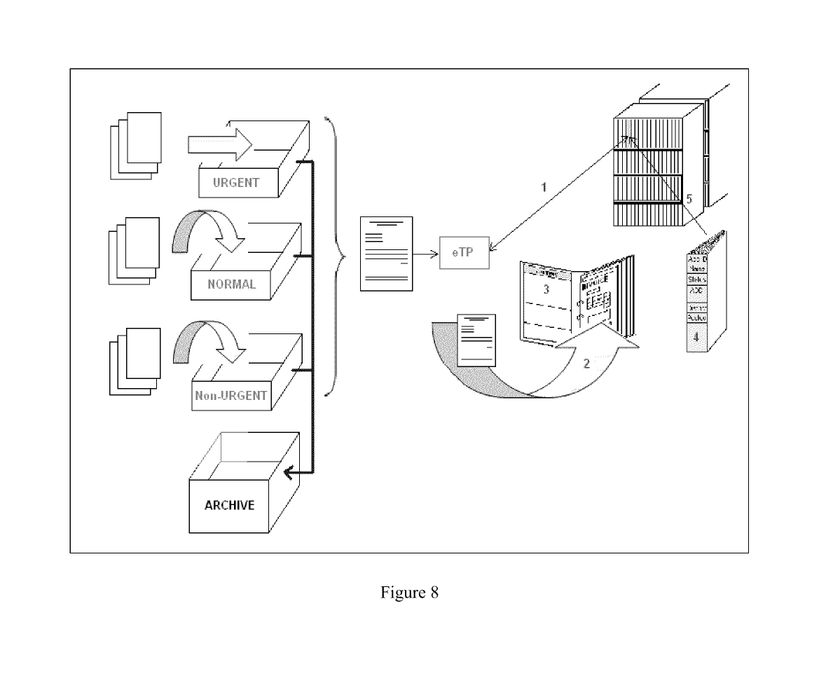

FIG. 8 shows a diagram on how a transaction eLedger and the document processor (eDP) interact with each other to perform the posting and updating processes. When an eDocument is presented to the eDP, the eDP will processes the document information and extracts system data (preferably such data is stored in a unique row refer as row code R000) which contain update instructions such as destination eLedger, target account, etc. Once the destination cabinet (eLedger) is identified, the corresponding account's folder will be retrieved (1). The eDP does not actually retrieves the whole folder, but only the Electronic Page-0 and the Document Zero. Depending on the space available on the Electronic Page-0, document X will be appended onto the Electronic Page as described previously (2), and the updated Electronic Page-0 (and ePage n if ePage 0 does not have enough space) will be stored to the appropriate eLedger (table) (5). Based on the update rules for this Document X, certain rows (R) will be updated to Document Zero and Line Zero accordingly (3 and 4).

Once an eDocument is successfully posted and filed to an account, eDP will updates the status of the eDocument in the “Inbox tray” (transaction eLedger) so that such processed eDocument will be collected and move to archive eLedger later. This is to ensure a better performance of the system as the read/write speed of a DBMS table is directly affected by the table size.

Transaction eLedger plays an important role in the ledger-filing system as any unsuccessful update will be logged and investigated. This not only provides a better traceability to the problems arise in the updating process, but also provides an immediate feedback to the system should any problems occur.

Library eLedger

Every system needs a library to keep track and standardize the terms as used in the system and to achieve better and more consistent references. Generally, they are two types of libraries: Standard Library and Specific Library. Standard library includes terms and codes that are broadly used by most of the people in the world and are seldom changed. Some of the example terms for Standard Library are countries, gender, salute, postcode, etc. Specific Library includes codes or terms that are used in limited applications, and are generally different from one organization to another, such as an organization's department, jobs title, etc. Specific Library also includes codes or terms that are specific to certain industry, such as course codes for an education industry, stock codes, etc.

In IT system, library terms or codes are usually used in the form of a pull down, or radio/tick box button as selection. A conventional library table in a typical RDBMS implementation will has minimum audit trail and a full audit history of a library code changes is not normally maintained.

As stated earlier, all eLedger updates use the same flow and same routine. Hence, all library codes creation or modification will require submission of document to the transaction eLedger.

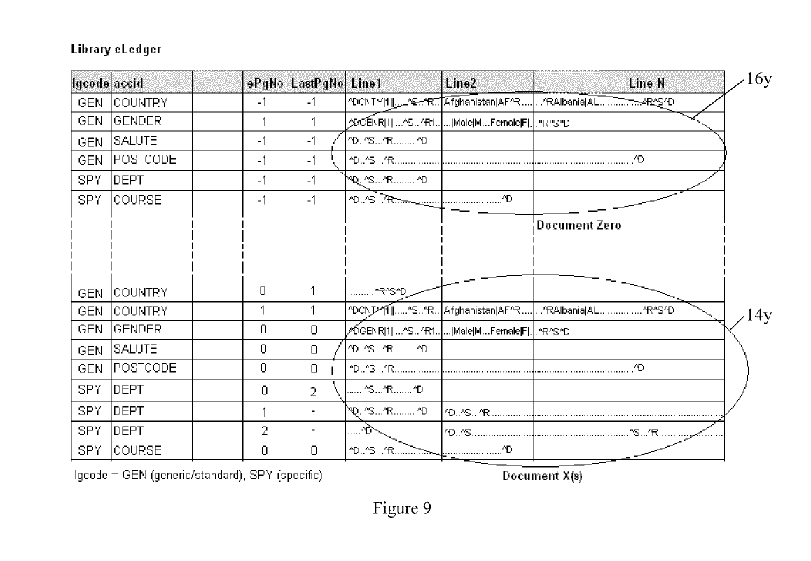

FIG. 9 shows an example of Library eLedger that implemented using a normal DBMS table. Note that Document Zero (16y) in a library eLedger is equivalent to the latest copy of the library code of the system, whereas Document X (14y) serves as the audit history of the changes made to the codes.

Dictionary eLedger

Dictionary eLedger in a way is very similar to library eLedger, except it is used to store all system related codes and parameters, including document update rules, business rules, work flows of a document and validation rules. The storage and retrieval mechanisms of the Dictionary eLedger are exactly the same as the library eLedger and the Dictionary eLedger uses the same update program (eDP).

Group eLedger

Group eLedger is used to group accounts based on criteria. A user can choose to group accounts by region, account code, or other criteria. Again, the storage mechanism and update method is exactly the same as other eLedgers.

Master eLedger

The function of the Master eLedger is similar to the Master record table found in the conventional RDBMS system. However, as eLedger of the present invention provides an account centric storage and retrieval method, storing and retrieving of data from the Master eLedger is much more easier as compared to the conventional system.

Ledger-filing system of this invention allows user to define more than one Master eLedger. Each of the Master eLedger can has its own unique Line Zero and Document Zero designs. For example, users can define a CUSTOMER Master eLedger, with Line Zero consists of customer name, address, deposit, arrears, Document Zero consists of more detail information such as billing address, referrer details, last 6 transactions history. Users can also define EQUIPMENT Master eLedger, with Line Zero consists of equipment ID, Name, Manufacturer information such as date, due date for service, accumulated amount spend to service, and the like, Document Zero consists of further details about the equipment such as last few service histories, supplier information, and the like.

The design of Line Zero and Document Zero is a function of the retrieval requirement. If searching and sorting of certain data is required, user should include it in the Line Zero fields, whereas Document Zero should contain more extensive information that answer questions regarding an account and often related to business intelligence and analysis of accounts.

Again, the posting and updating of information in a Master eLedger are exactly the same as other eLedgers.

Operation eLedger

Operation eLedger is used in the present invention to store scheduled and time sensitive documents. As the present ledger-filing system works by encapsulate everything under a document (eDocument), for document that required routine submission (like once a day, once a week, first day of a month, or every Monday and Friday, or the like), action that need to be taken periodically, will be submitted to Operation eLedger.

As the eLedger of the present invention is an account centric storage system, to facilitate Operation eLedger requirements, Operation eLedger's account ID will be date-time basis. Document X will be posted to their respective date-time account and updated to its Document Zero. A scheduler programs will run constantly at the back and retrieve all Document Zero(s) that match the current date-time and submit those document to transaction eLedger for processing.

Again, the posting and updating of information in Operation eLedger is exactly the same as any other eLedgers described above.

Index eLedger

The ledger-filing system according to this invention provides a program to crawl through each account and index the information contains in each eLedger. The information indexed will be stored as eDocument in index eLedger. The sole purpose of Index eLedger is to facilitate better searching performance. The mechanism on how this index eDocument is stored and retrieved is exactly the same as any other eLedgers.

Summary eLedger

The invention uses Summary eLedger to aggregate data based on user specify criteria. User can create multiple summary eLedgers that aggregate data with different criteria and create different “view” of the information. Examples of Summary eLedgers include payment (eDocument) received by region, by month, by amount. Summary eLedger normally will not utilize Document Zero, but Line Zero will be heavily used, specifically for reporting and enquiry.

Every time a Summary account is updated, a Document X will be appended to the account to preserve audit trail and keep track on when is the last time a summary is compiled and updated. Again, posting and updating of information in Summary eLedger is exactly the same as any other eLedgers.

Audit eLedger

The present invention employs a special program to perform self audit on each eLedger to detect any erroneous or “unbalance” transactions. Audit report will be generated and submitted to Audit eLedger for record purposes. User can specify the frequency of the audit and set the checking parameters for each of the audit activities. Again, posting and updating of information in Audit eLedger is exactly the same as any other eLedgers.

Bulk Storage eLedger

In the conventional physical filing system, we use store room to keep any large items that cannot be filed in a cabinet. We normally label these bulky items and organized them so that we can retrieve these items subsequently. Likewise, the ledger-filing system of the present invention consists a special eLedger that allow storing of big files, such as video, image, audio and any other multimedia or binary data files so that the performance is optimized for both storing and retrieving.

Bulk Storage eLedger is virtually the same as other eLedgers, except for the ePage consists of one line only, and typically the line size is in Kilo/Megabyte rather than 128 bytes. The filing and updating processes are exactly the same as other eLedgers, and hence same update program is used for any posting and filing processes.

In a DBMS implementation for such a bulk storage eLedger a large column with a 1 MB line size is using a BLOB data type and if a binary file is larger than 1 MB, it will be divided and segmented into multiple segments and store in multiple ePage (rows in a table).

The ePage's line size is customizable and is very important for performance in term of storing and retrieving. By dividing the data into multiple ePages, a large binary file can be retrieved and send to an user an ePage at a time and increase the response time for large file retrieval tremendously. This is especially true for applications that acquire streaming method to transfer large file size such as video and audio streaming.

In another embodiment of the present invention, a computer program having a module for storing, integrating, managing, retrieving and organizing data obtained from a resource where execution of said module generates a method of data storage and management as described above which comprises the steps of:

a). converting said obtained data into an electronic document having a pre-determined structure which is computer-readable (101);
b). storing said electronic document in a temporary storage means where all the converted data is stored (102);
c). identifying destination file to store said electronic document (103);
d). retrieving a pre-determined electronic page of said destination file where the most recent electronic document is recorded (104);
e). appending said electronic document onto said retrieved page in chronological order (105);
f). updating said destination file according to the data of said electronic document as appended (106);
g). storing said updated destination file in a specific storage means (107)

According to the present invention, the storage means comprises at least a virtual folder that stores data and the storage means may comprises multiple virtual folders having substantially similar design according to the storage needs.

The computer program further comprises a module of assigning each electronic document (14) a priority level and processing each electronic document (14) according to the priority level as assigned. Whenever more than one electronic documents (14) are assigned with the same priority level, the electronic documents (14) will be processed in sequence according to the date and time as entered into the system.

In the preferred embodiment of the present invention, the computer program may further comprises an update module consists a set of update rules in which whenever an electronic document (14) is received by said memory device, the processor will cross-reference the electronic document (14) with the update rules and update the destination file accordingly. More preferably, the update rules comprise: (i). reading said converted electronic document (14) stored in said temporary storage means; (ii). identifying the destination file to store said electronic document (14); (iii). retrieving a pre-determined electronic page (12) of said destination file where the most recent electronic document is recorded; (iv). appending said electronic document (14) onto said retrieved page in chronological order; (v). updating said destination file according to the data of said electronic document (14) as appended; (vi). updating the processing status of said electronic document (14) stored in said temporary storage means upon appending and updating the relevant electronic document (14) into said destination file. The processing status is an indication showing the success or failure of the appending and updating processes of the electronic document (14) into the destination file.

A further embodiment of the present invention relates to a computer system comprising at least: (i). a processor; (ii). a memory device operatively coupled to said processor; iii). a storage medium operatively coupled to said processor; wherein said memory device is stored with a module where execution of said module by said processor generates a method of data storage and management as described above which comprises the steps of:

a). receiving data (100);
b). converting said obtained data into an electronic document having a pre-determined structure which is computer-readable (101);
c). storing said electronic document in a temporary storage means where all the converted data is stored (102);
d). identifying destination file to store said electronic document (103);
e). retrieving a pre-determined electronic page of said destination file where the most recent electronic document is recorded (104);
f). appending said electronic document onto said retrieved page in chronological order (105);
g). updating said destination file according to the data of said electronic document as appended (106);
h). storing said updated destination file in a specific storage means (107)

The foregoing descriptions of specific embodiments of the present invention have been presented for purposes of illustration and description. They are not intended to be exhaustive or to limit the invention to the precise forms disclosed, and obviously many modification and variations are possible. The embodiments were chosen and described in order to best explain the principles of the invention and its practical application, to hereby enable others skilled in the art to best utilize the invention and various embodiments with various modifications as are suited to the particular are contemplated. It is intended that the scope of the invention be defined by the claims appended hereto and their equivalents.

1-84. (canceled)

85. A method of electronic data storage, integration, management, retrieval and organization comprising the use of account-centric non-table driven methodologies.

86. The method as claimed in claim 85, comprising creating an electronic document structure using a database table comprising one or more data columns, wherein each data column is capable of comprising at least two different elements of said electronic document structure.

87. The method as claimed in claim 86, further comprising inserting markers and codes as part of the electronic document structure to denote said different elements.

88. The method as claimed in claim 85, wherein said different elements are arranged as a string of characters.

89. The method as claimed in claim 85, comprising storing the content of a document such that an electronic document representing said content is stored in one or more consecutive data columns of the database table.

90. The method as claimed in claim 89, wherein said storing the content comprises:
storing said electronic document in a temporary storage means;
identifying a destination file to store said electronic document;
retrieving a pre-determined electronic page of said destination file where a most recent electronic document is recorded;
appending said electronic document onto said retrieved page in chronological order;
updating said destination file according to the content represented by said electronic document as appended; and
storing said destination file in a specific storage means.

91. The method as claimed in claim 90, wherein electronic documents of a same account are grouped and stored in the same storage means.

92. The method as claimed in claim 90, wherein said electronic page comprises one or more columns.

93. The method as claimed in claim 92, wherein a column length is of the order of bytes, Kilobytes or Megabytes.

94. The method as claimed in claim 90, wherein said pre-determined electronic page is identified in the form of page-N₀, where N₀ is the first member in a set of symbols with a fixed order.

95. The method as claimed in claim 94, wherein whenever said pre-determined electronic page is fully appended with electronic documents, the identification of the page will be changed to page-N, where N is the members of said set of symbols and a new electronic page will be generated and given the identification of page-N₀.

96. The method as claimed in claim 90, wherein said electronic document appended onto said electronic page continues to the next electronic page whenever a current electronic page is full.

97. The method as claimed in claim 90, wherein each destination file comprises a section for storing retrieval keywords for data retrieval purposes.

98. The method as claimed in claim 90, wherein each destination file comprises an area that stores an activities summary.

99. The method as claimed in claim 98, wherein said area stores variable length data.

100. The method as claimed in claim 98, wherein said area is given a specific identification and relevant data is updated to said area whenever an electronic document is appended.

101. The method as claimed in claim 98, wherein said area comprises multiple pages for recording electronic documents that store the activities summary.

102. The method as claimed in claim 101, wherein said multiple pages are given a reverse page numbering system starting from Page-1.

103. The method as claimed in claim 90, wherein said method further comprises assigning each electronic document a priority level and processing each document according to the priority level as assigned.

104. A system for electronic data storage, integration, management, retrieval and organization, the system being account-centric and non-table driven.

105. The system as claimed in claim 104, comprising means for creating an electronic document structure using a database table comprising one or more data columns, wherein each data column is capable of comprising at least two different elements of said electronic document structure.

106. The system as claimed in claim 105, wherein said means for creating an electronic document structure inserts markers and codes as part of the electronic document structure to denote said different elements.

107. The system as claimed in claim 105, wherein said different elements are arranged as a string of characters.

108. The system as claimed in claim 105, comprising means for storing the content of a document such that an electronic document representing said content is stored in one or more consecutive data columns of the database table.

109. The system as claimed in claim 108, wherein said means for storing the content:
stores said electronic document in a temporary storage means;
identifies a destination file to store said electronic document;
retrieves a pre-determined electronic page of said destination file where a most recent electronic document is recorded;
appends said electronic document onto said retrieved page in chronological order;
updates said destination file according to the content represented by said electronic document as appended; and
stores said destination file in a specific storage means.

110. The system as claimed in claim 109, wherein electronic documents of a same account are grouped and stored in the same storage means.

111. The system as claimed in claim 109, wherein said electronic page comprises one or more columns.

112. The system as claimed in claim 111, wherein a column length is of the order of bytes, Kilobytes or Megabytes.

113. The system as claimed in claim 109, wherein said pre-determined electronic page is identified in the form of page-N₀, where N₀ is the first member in a set of symbols with a fixed order.

114. The system as claimed in claim 113, wherein whenever said pre-determined electronic page is fully appended with electronic documents, the identification of the page will be changed to page-N, where N is the members of said set of symbols and a new electronic page will be generated and given the identification of page-N₀.

115. The system as claimed in claim 109, wherein said electronic document appended onto said electronic page continues to the next electronic page whenever a current electronic page is full.

116. The system as claimed in claim 109, wherein each destination file comprises a section for storing retrieval keywords for data retrieval purposes.

117. The system as claimed in claim 109, wherein each destination file comprises an area that stores an activities summary.

118. The system as claimed in claim 117, wherein said area stores variable length data.

119. The system as claimed in claim 117, wherein said area is given a specific identification and relevant data is updated to said area whenever an electronic document is appended.

120. The system as claimed in claim 117, wherein said area comprises multiple pages for recording electronic documents that store the activities summary.

121. The system as claimed in claim 120, wherein said multiple pages are given a reverse page numbering system starting from Page-1.

122. A computer readable data storage medium having stored thereon computer code means for instructing a computer to execute a method of electronic data storage, integration, management, retrieval and organization, the method comprising the use of account-centric non-table driven methodologies.

123. The computer readable data storage medium as claimed in claim 122, the method comprising creating an electronic document structure using a database table comprising one or more data columns, wherein each data column is capable of comprising at least two different elements of said electronic document structure.

124. The computer readable data storage medium as claimed in claim 123, the method further comprising inserting markers and codes as part of the electronic document structure to denote said different elements.

125. The computer readable data storage medium as claimed in claim 123, wherein said different elements are arranged as a string of characters.

126. The computer readable data storage medium as claimed in claim 123, the method comprising storing the content of a document such that an electronic document representing said content is stored in one or more consecutive data columns of the database table.

127. The computer readable data storage medium as claimed in claim 126, wherein said storing the content comprises:
storing said electronic document in a temporary storage means;
identifying a destination file to store said electronic document;
retrieving a pre-determined electronic page of said destination file where a most recent electronic document is recorded;
appending said electronic document onto said retrieved page in chronological order;
updating said destination file according to the content represented by said electronic document as appended; and
storing said destination file in a specific storage means.
